(19) United States
(12) Patent Application Publication
(10) Pub. No.: US 2009/0035680 A1
(43) Pub. Date: Feb. 5, 2009

(54) POSITIVE CHARGE CONTROLLING AGENT, PROCESS FOR PRODUCING THE SAME, AND ELECTROPHOTOGRAPHIC TONER CONTAINING THE SAME

(75) Inventors: Takayuki Ishimoto, Saitama-shi (JP); Shinji Yatabe, Tatebayashi-shi (JP)

Correspondence Address: WOOD, HERRON & EVANS, LLP, 2700 CAREW TOWER, 441 VINE STREET, CINCINNATI, OH, 45202, US

(73) Assignee: FUJIKURA KASEI CO., LTD., Tokyo (JP)

(21) Appl. No.: 11/997,329

(22) PCT Filed: Apr. 23, 2007
(86) PCT No.: PCT/JP2007/058756

§ 371 Date: Jan. 30, 2008

(30) Foreign Application Priority Data
May 29, 2006 (JP) 2006-148320

(51) Int. Cl. G03G 9/16; C08F 226/02; C08F 4/34

(52) U.S. Cl. 430/108.2; 526/312; 526/227

(57) ABSTRACT

Provided are a positive charge controlling agent which is excellent in compatibility with and dispersibility in a binder resin, prevented from discoloring, excellent in chargeability, and reduced in the content of organic compounds having low boiling points, thereby giving no strong odor; a process for producing the same; and an electrophotographic toner which exhibits excellent chargeability and colorability, and the controlled production of VOC. The positive charge controlling agent includes a copolymer obtained by copolymerizing a styrene monomer (M1), a (meth)acrylic acid alkyl ester monomer (M2), and a quaternary ammonium salt (M3) of a dialkylaminoalkyl(meth)acrylate monomer, wherein a copolymerizing ratio (mass %) of the monomers, (M1)+(M2):(M3), is 99.5:0.5 to 65:35, and at least one end thereof is RCOO— or RO—, where R is an alkyl group, an aryl group, an aralkyl group, or an alicyclic group.

### TECHNICAL FIELD

The present invention relates to an electrophotographic toner for attaining a visible image from an electrostatic image in electrophotography, a positive charge controlling agent employed therein, and a process for producing the agent.

This application claims priority from Japanese Patent Application No. 2006-148320 filed on May 29, 2006, the disclosure of which is herein incorporated by reference in its entirety.

### BACKGROUND ART

There are various known electrophotographic processes, but the generally known one is a process including the steps of forming a latent image from the electrostatic charge on a photoconductive material (photoreceptor), adhering toner particles containing a binder resin and a colorant dispersed in the binder resin to visualize the latent image, transferring the visualized image to a medium such as paper and plastic film as appropriate, and then fixing the toner image to the medium using heat and pressure or the like.

The toner particles mainly contain a colorant, a binder resin, a positive charge controlling agent, and the like, and it is desirable that the positive charge controlling agent be compatible with and dispersible in the binder resin.

For producing the positive charge controlling agent, an azo-based initiator is usually used as the polymerization initiator (for example, see Patent Document 1).

However, recombination and disproportionation readily occur after the generation of radicals in the azo-based initiator (cage effect) which results in a low initiator efficiency. By-products produced in the recombination and disproportionation are believed to be organic compounds having low boiling points. Thus, when a toner which is prepared by using a positive charge controlling agent obtained with the use of the azo-based initiator is used upon fixing, a volatile organic compound (VOC) is produced, possibly associating with a strong odor.

Consequently, there has been studied a way of preventing the production of VOC by using a peroxide-based initiator which is high in the initiator efficiency instead of using the azo-based initiator.

Patent Document 1: JP-B-8-3658

### DISCLOSURE OF THE INVENTION

However, when the peroxide-based initiator is used, there may be a case where an obtained positive charge controlling agent exhibits low chargeability or gives a dark brown color. Accordingly, a toner which contains the positive charge controlling agent obtained using the peroxide-based initiator may exhibit low chargeability and colorability, meaning that a color tone may be affected when a color toner or the like is used. As a result, a problem may arise in that the printing quality may be deteriorated.

The present invention is made in the light of these considerations, and the object of which is to provide: a positive charge controlling agent which is excellent in compatibility with and dispersibility in a binder resin, prevented from discoloring, excellent in chargeability, and reduced in the content of organic compounds having low boiling points, thereby giving no strong odor; a process for producing the same; and an electrophotographic toner which exhibits excellent chargeability and colorability, and the controlled production of VOC.

The present inventors have measured a content of organic compounds having low boiling points in a positive charge controlling agent which is obtained with the use of an azo-based initiator using gas chromatography, and they have sensed an odor when a toner which is prepared by using a positive charge controlling agent having the content greater than 0.8 mass % is used in printing. In addition, when an odor measuring test is performed for the positive charge controlling agent, a strong odor is clearly sensed.

Further, since the reaction between amine in a monomer constituting a copolymer and a peroxide-based initiator, occurring before the polymerization, causes impaired chargeability of and discoloring in the positive charge controlling agent, a way was found to prevent the reaction with a peroxide-based initiator by preliminarily quaternizing the monomer containing amine. There was carried out a further investigation on the basis of this finding, and the following positive charge controlling agent, production process, and toner employing the agent were invented.

The invention includes the following constitutions:

[1] A positive charge controlling agent containing a copolymer obtained by copolymerizing a styrene monomer (M1), a (meth)acrylic acid alkyl ester monomer (M2), and a quaternary ammonium salt (M3) of a dialkylaminoalkyl(meth)acrylate monomer,

wherein a copolymerizing ratio (mass %) of the monomers is (M1)+(M2):(M3)=99.5:0.5 to 65:35, and at least one end is RCOO— or RO—, where R is an alkyl group, an aryl group, an aralkyl group, or an alicyclic group;

[2] A process for producing the positive charge controlling agent described in [1], including converting the dialkylaminoalkyl(meth)acrylate monomer into the quaternary ammonium salt by quaternization, and then copolymerizing with the styrene monomer and the (meth)acrylic acid alkyl ester monomer with the use of a peroxide-based initiator;

[3] The process described in [2], wherein the quaternary ammonium salt (M3) of the dialkylaminoalkyl(meth)acrylate monomer is represented by the following formula (1):

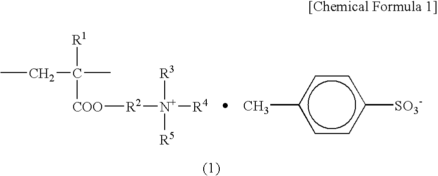

wherein R¹ is a hydrogen atom or a methyl group, R² is an alkylene group, and R³ to R⁵ are each an alkyl group;

[4] The positive charge controlling agent described in [1], wherein the content of organic compounds having low boiling points is 0.8 mass % or less; and

[5] An electrophotographic toner comprising 0.1 to 20 parts by mass of the positive charge controlling agent described in [1] or [4], with respect to 100 parts by mass of a binder resin.

### ADVANTAGES OF THE INVENTION

According to the invention, there can be provided a positive charge controlling agent which is excellent in compatibility with and dispersibility in a binder resin, prevented from discoloring, excellent in chargeability, and reduced in the content of organic compounds having low boiling points, thereby giving no odor; a process for producing the same; and an electrophotographic toner which exhibits excellent chargeability and colorability, and the controlled production of VOC.

### BEST MODE FOR CARRYING OUT THE INVENTION

Hereinafter, the invention will be explained in detail.

The positive charge controlling agent according to the invention includes a copolymer including the styrene monomer (M1), the (meth)acrylic acid alkyl ester monomer (M2), and the quaternary ammonium salt (M3) of a dialkylaminoalkyl(meth)acrylate monomer, as the structural units.

Examples of M1 include styrene, α-methylstyrene, p-methylstyrene, p-chlorostyrene, and the like, but styrene is preferred among them.

Examples of M2 include methyl(meth)acrylate, ethyl(meth)acrylate, butyl(meth)acrylate, propyl(meth)acrylate, amyl(meth)acrylate, 2-ethylhexyl(meth)acrylate, cyclohexyl(meth)acrylate, lauryl(meth)acrylate, stearyl(meth)acrylate, and the like, but butyl(meth)acrylate and 2-ethylhexyl(meth)acrylate are preferred among them.

M3 is a quaternary ammonium salt of dialkylaminoalkyl(meth)acrylate, and preferably has a structure represented by the above formula (1).

In the formula (1), R¹ is a hydrogen atom or a methyl group, R² is an alkylene group, and R³ to R⁵ are each an alkyl group. Examples of the alkylene group include a methylene group, an ethylene group, a propylene group, a butylene group, and the like, but an ethylene group is preferred among them. Examples of the alkyl group include a methyl group, an ethyl group, a propyl group, an n-butyl group, a t-butyl group, and the like, but a methyl group is preferred among them.

Examples of the dialkylaminoalkyl(meth)acrylate include dimethylaminoethyl(meth)acrylate, diethylaminoethyl(meth)acrylate, dipropylaminoethyl(meth)acrylate, dibutylaminoethyl(meth)acrylate, and the like, but dimethylaminoethyl(meth)acrylate is preferred among them.

The process for producing the copolymer includes preliminarily converting the dialkylaminoalkyl(meth)acrylate into M3 by quaternization with the use of a paratoluene sulfonic acid alkyl ester in accordance with the common method, and then copolymerizing with M1 and M2 in the presence of a polymerization initiator. Examples of the paratoluene sulfonic acid alkyl ester include methyl paratoluene sulfonic acid, ethyl paratoluene sulfonic acid, propyl paratoluene sulfonic acid, and the like, but methyl paratoluene sulfonic acid is preferred among them. The used amount of paratoluene sulfonic acid alkyl ester is in the range of usually 0.8 to 1.5 mol and preferably 1.0 to 1.2 mol, per 1 molar unit of the dialkylaminoalkyl(meth)acrylate which is reacted therewith.

As such, when the dialkylaminoalkyl(meth)acrylate is quaternized in advance, the reaction between the polymerization initiator to be described later and amine in the dialkylaminoalkyl(meth)acrylate can be prevented. The produced copolymer is excellent in chargeability and prevents coloring, and such a copolymer can be used to obtain a toner excellent in chargeability and colorability.

As the polymerization initiator, peroxide-based initiators having a 10-hour half-life temperature of 120° C. or less are preferable, and examples thereof include t-butylperoxy-2-ethylhexanoate, t-amylperoxy-2-ethylhexanoate, t-hexylperoxy-2-ethylhexanoate, t-butylperoxyisobutylate, 1,1-di(t-butylperoxy)cyclohexane, Di-benzoyl peroxide, succinic peroxide, dilauroyl peroxide, and the like. Among them, t-butylperoxy-2-ethylhexanoate, t-amylperoxy-2-ethylhexanoate, 1,1-di(t-butylperoxy)cyclohexane, and Di-benzoyl peroxide are preferable, and t-butylperoxy-2-ethylhexanoate is particularly preferable.

The polymerization initiator is preferably used in the range of 0.5 to 20 parts by mass with respect to the total mass of the monomeric mixture used, provided that the total mass of the monomeric mixture is 100 parts by mass.

Since a copolymer obtained using the above-mentioned peroxide-based initiator contains a small amount of organic compounds having low boiling points, a toner employing this copolymer is controlled in the production of VOC upon fixing.

There is no limitation on the copolymerization process and any processes such as solution polymerization, suspension polymerization, bulk polymerization, and emulsion polymerization may be employed, but from the viewpoints of relatively easy control of mass average molecular weight of a copolymer to be obtained and its simple reaction operation, it is particularly preferable to employ a solution polymerization process which copolymerizes a monomeric mixture in either an organic solvent such as benzene, toluene, xylene, dioxane, propylene glycol monomethyl ether, ethylene glycol monomethyl ether, ethyl acetate, isopropyl acetate, methyl ethyl ketone, diethyl ketone, and isobutyl ketone, or lower alcohol such as methanol, ethanol, propanol, isopropanol, butanol, isobutanol, sec-butanol, and t-butanol. Among those solvents, it is preferable to at least use the lower alcohol.

For the copolymer to be used in the invention, the copolymerizing ratio (mass %) of monomers, (M1)+(M2):(M3), is 99.5:0.5 to 65:35, preferably 99:1 to 70:30.

When the content of M3 is less than 0.5 mass % and such a copolymer is employed as the positive charge controlling agent in a toner, the chargeability from the positive charge controlling agent tends to be insufficient. Meanwhile, when the content is greater than 35 mass %, the compatibility with a binder resin tends to be poor and also the humidity resistance tends to be insufficient.

In addition, as mentioned above, the copolymer obtained using the peroxide-based initiator has RCOO— or RO— on at least one end. R is an alkyl group, an aryl group, an aralkyl group, or an alicyclic group, and preferably an alkyl group or an aryl group.

The mass average molecular weight of the copolymer is preferably within the range of 1,500 to 100,000. Within this range, the chargeability is hardly deteriorated even in a high humid environment, and the offset where toner adheres and remains on the surface of a fixing roller upon fixing hardly occurs. In addition, when the copolymer with the mass average molecular weight within such range is employed in a toner, excellent compatibility with and dispersibility in a binder resin are obtained, and even when the toner is used with a carrier, toner spending such as by toner particles being crushed hardly occurs. The mass average molecular weight of the copolymer is more preferably within the range of 3,000 to 50,000.

Furthermore, when the copolymer having a glass transition temperature of 50 to 80° C. is employed in a toner, excellent storage stability at high temperature can be exhibited while maintaining the adhesion ability.

The content of organic compounds having low boiling points is preferably 0.8 mass % or less, thereby preventing the VOC production upon the use as a toner.

When a positive charge controlling agent containing the copolymer obtained in such a manner is blended with a binder resin together with a colorant and other additives as appropriate to give particles having a mean particle diameter of, for example, about 3 to 25 μm, there can be obtained a toner which is improved in chargeability, and the spending of which hardly occurs even when mixed with a carrier by stirring. The preferred blending amount of the positive charge controlling agent is usually from 0.1 to 20 parts by mass with respect to 100 parts by mass of the binder resin.

When the blending amount of the positive charge controlling agent is less than 0.1 parts by mass, it is more likely that the sufficient chargeability cannot be obtained. Meanwhile, when the amount is greater than 20 parts by mass, the offset generation temperature tends to decrease, the chargeability under high temperature and high humidity tends to decrease (resistance to environment deteriorates), the compatibility with the binder resin to be described later tends to be poor, etc.

As the binder resin to be used in a toner, a styrene-acryl resin, a polyester resin, an epoxy resin, a cycloolefin resin, or the like, is preferable, and these may be used alone or in combination of two or more kinds. In particular, a styrene-acryl resin and a polyester resin are preferable.

The styrene acryl resin can be exemplified by a copolymer of styrene and/or α-methylstyrene and (meth)acrylic acid alkyl ester, and examples of the (meth)acrylic acid alkyl ester include methyl(meth)acrylate, ethyl(meth)acrylate, butyl(meth)acrylate, propyl(meth)acrylate, amyl(meth)acrylate, 2-ethylhexyl(meth)acrylate, cyclohexyl(meth)acrylate, lauryl(meth)acrylate, stearyl(meth)acrylate, and the like. Among them, methyl(meth)acrylate, ethyl(meth)acrylate, propyl(meth)acrylate, n-butyl(meth)acrylate, and 2-ethylhexyl(meth)acrylate are preferable for a use. These may be used alone or in combination of two or more kinds.

The copolymerizing ratio of styrene and/or α-methylstyrene, and (meth)acrylic acid alkyl ester, which is styrene and/or α-methylstyrene:(meth)acrylic acid alkyl ester, is preferably in the range of 50:50 to 90:10, and more preferably in the range of 60:40 to 85:15, in a mass ratio.

Such a styrene-acryl resin has the glass transition temperature in the range of preferably about 50 to 80° C., and more preferably about 50 to 70° C.

Further, such a styrene-acryl resin has the ratio of mass average molecular weight to number average molecular weight (mass average molecular weight/number average molecular weight) in the range of preferably 2 to 50, and more preferably 10 to 40.

The styrene-acryl resin may contain a small amount of a third monomer unit, preferably, the amount in the range of 3 mass % or less in the styrene-aryl resin. The third monomer unit may be any compounds as long as it is a compound having 2 or more copolymerizable unsaturated groups in one molecule, and examples thereof include alkylene or di-, poly-alkylene glycol di(meth)acrylate, such as ethylene glycol di(meth)acrylate, diethylene glycol di(meth)acrylate, polyethylene glycol di(meth)acrylate, propylene glycol di(meth)acrylate, and butandiol di(meth)acrylate; poly(meth)acrylates of polyalcohol such as trimethylolpropane tri(meth)acrylate; allyl(meth)acrylate; divinylbenzene and divinylnaphthalene; and the like, and these may be used as a monomer to give a resin partially having a three-dimensional crosslinked structure.

A polyester resin to be used in the binder resin is constituted by a dicarboxylic acid component and a glycol component in principal.

Examples of the dicarboxylic acid component include maleic acid, fumaric acid, mesaconic acid, citraconic acid, itaconic acid, glutaconic acid, phthalic acid, isophthalic acid, terephthalic acid, dichlohexane dicarboxylic acid, succinic acid, adipic acid, sebacic acid, malonic acid, linoleic acid, etc., and anhydrides thereof and lower alcohol esters thereof.

Examples of the glycol component include ethylene glycol, propylene glycol, butylene glycol, neopentyl glycol, hexanediol, diethylene glycol, triethylene glycol, polyethylene glycol, dimethylol benzene, cyclohexanedimethanol, bisphenol A, hydrogenated bisphenol A, and the like.

In order to further improve properties of the toner, a part of the glycol component in the polyester resin may be substituted with trivalent or quadrivalent alcohol such as sorbitol, hexatetrol, dipentaerythritol, glycerol, cane sugar, or the like, or a part of the carboxylic acid component in the polyester resin may be substituted with trivalent or quadrivalent carboxylic acid such as benzene tricarboxylic acid, cyclohexane tricarboxylic acid, naphthalene tricarboxylic acid, butane tricarboxylic acid, trimellitic acid, pyromellitic acid, or the like, so as to partially give a three-dimensional crosslinked structure. Alternatively, an epoxy group, a urethane bond, or the like may be appropriately introduced to give a partially crosslinked structure or a graft form.

An epoxy resin to be used in the binder resin includes those having two or more epoxy groups in one molecule on average, and the softening temperature of preferably 50 to 170° C., more preferably 60 to 150° C., the molecular weight of 700 to 8,000, more preferably 900 to 6,000, and the epoxy equivalent of 150 to 4,000, more preferably 200 to 3,500. Examples of the epoxy resin include a bisphenol A type epoxy resin, a hydrogenated bisphenol A type epoxy resin, a novolak type epoxy resin, a polyalkylene ether type epoxy resin, a cyclic aliphatic type epoxy resin, and the like.

There is no particular limitation on a colorant applicable to be contained in the toner as necessary, and examples thereof include carbon black, phthalocyanine colorants, nigrosine dye (C.I. No. 50415B), Aniline blue (C.I. No. 50405), charco oil blue (C.I. No. Azoic Blue 3), chrome yellow (C.I. No. 14090), ultramarine blue (C.I. No. 77103), DuPont oil red (C.I. No. 26105), quinoline yellow (C.I. No. 47005), methylene blue chloride (C.I. No. 52015), phthalocyanine blue (C.I. No. 74160), malachite green oxalate (C.I. No. 42000), lamp black (C.I. No. 77266), rose bengale (C.I. No. 45435), and the like, and these may be used alone or in combination of two or more kinds.

These colorants are blended in a mass proportion capable of forming a visible image with sufficient density, but it is usual to be blended in the amount of about 1 to 20 parts by mass, preferably 2 to 7 parts by mass, with respect to 100 parts by mass of the binder resin.

Further, according to need, the toner my be further blended with an agent with a parting property such as higher fatty acids or metals salts of higher fatty acids, natural or synthetic waxes, higher fatty acid esters or partially saponified products thereof, alkylene bis-fatty acid amides, a fluorine resin, or a silicone resin, for the purpose of improving the toner properties and offset resistance. The blending ratio thereof is about 1 to 10 parts by mass with respect to 100 parts by mass of the binder resin.

In addition, in order to maintain the fluidity and storage stability of the toner, colloidal silica, hydrophobic silica, or the like, may be blended in the range of about 0.1 to 3 parts by mass with respect to 100 parts by mass of toner particles, thereby allowing the surface treatment of the toner particles.

For preparing the toner, the above-mentioned components are thoroughly mixed by a mixer such as a Henschel mixer, a ball mill, or the like, thereafter the mixture is melt and kneaded by a heat kneading machine such as a heat roller, a kneader, an extruder, or the like, and then the kneaded matter is cooled and solidified. Next, the cooled matter is pulverized by a pulverizer such as a hammer mill or a jet mill, and the pulverized matter is classified to collect particles having a mean particle diameter of preferably 3 to 20 μm, thereby preparing the toner.

Alternatively, the toner may also be prepared by a spray dry method which includes spray-drying an organic solvent solution of the components dissolved or dispersed therein under a temperature condition of 200° C. or below; a copolymerizing method which includes mixing the monomeric mixture which is to constitute the binder resin with the other components to give a suspension liquid and thereafter subjecting the suspension liquid to copolymerization; a flocculating method which includes subjecting a monomeric mixture which is to constitute the binder resin to emulsion copolymerization and thereafter mixing with the other components for flocculation, or the like.

A positive charge controlling agent obtained in such a manner exhibits excellent compatibility with and dispersibility in the binder resin, and since the content of organic compounds having low boiling points is reduced, a production of VOC is prevented when such an agent is employed in a toner, thereby giving no odor to be sensed. Further, since the chargeability of the positive charge controlling agent can be improved and the discoloring can be prevented by preventing the reaction between amine in a monomer which is to constitute a copolymer contained in the positive charge controlling agent, and a polymerization initiator, a toner excellent in chargeability and colorability can be obtained.

The positive charge controlling agent described above may also be used for other purposes in addition to the toner as mentioned above, for example, it may be used to coat a carrier or a blade equipped to an electrophotographic device so as to positively charge the carrier, blade, or the like, which had been coated. By this coating, the toner is efficiently negatively charged.

Further, this positive charge control agent can be used in powdered coating materials for electrostatic coating.

### EXAMPLES

Hereinafter, the invention will be described in more detail with reference to Examples, but the invention is not limited by those. In Examples, “part” denotes “parts by mass” and “%” denotes “mass %”.

### Example 1

### Production of Positive Charge Controlling Agent

A 2-liter flask equipped with a stirrer, a condenser, a thermometer, and a nitrogen introducing tube was charged with 180 g of isobutanol as the reaction solvent, and 18 g of diethylaminoethyl(meth)acrylate and 18 g of methyl paratoluene sulfonic acid were added thereto. The mixture was stirred for 1 hour at 80° C. under a nitrogen atmosphere to subject a quaternization reaction. Thereafter, 210 g of styrene, 72 g of butylacrylate, and 12 g of t-butylperoxy-2-ethylhexanoate (produced by ARKEMA YOSHITOMI, LTD.) which serves as a peroxide-based initiator, were added while introducing nitrogen, the mixture was heated to 95° C. (polymerization temperature), and stirred for 3 hours. To this reaction solution, 6 g of t-butylperoxy-2-ethylhexanoate was further added, and the mixture was stirred for 3 hours to obtain a polymer solution.

The polymer solution was dried with heating under reduced pressure (initial temperature of 140° C., pressure is reduced down to 10 kPa or below) to remove the solvent fraction, thereby obtaining a polymer. This polymer was subjected to cracking to obtain a positive charge controlling agent.

The copolymerizing ratio (%) of the styrene monomer (M1), the (meth)acrylic acid alkyl ester monomer (M2), and the quaternary ammonium salt (M3) of the dialkylaminoalkyl(meth)acrylate monomer, (M1)+(M2):(M3), was 88.7:11.3.

Toner Preparation: T-1

100 parts of a styrene-acryl copolymer resin, 3 parts of the positive charge controlling agent, 4 parts of carbon black (manufactured by Mitsubishi Kasei Corp. MA #100), and 3 parts of Biscol 550P (manufactured by Sanyo Chemical Industries, Ltd.) were blended, and the blend was melt-kneaded by a Laboplasto mill (manufactured by Toyo Seiki Co., Ltd.). The kneaded mixture was pulverized by a jet mill (manufactured by Nippon Pneumatic MFG. Co., Ltd.), and then the particles were classified to produce a toner having a particle diameter of 5 to 15 μm. To this toner, 0.6 parts of Silica R-972 (manufactured by Japan AEROSIL) was uniformly applied as an external additive.

Various Measurements and Evaluation

With regard to the obtained positive charge controlling agent and toner, the following measurements and evaluation were carried out. The results are shown in Table 1.

(a) Gas Chromatography Measurement (Measurement for Organic Compound having Low Boiling Point)

With the use of a gas chromatograph (manufactured by Hitachi, Ltd., G3000) employing a column (manufactured by GL science, TC-1), 1 μl of injected sample was subjected to measurement under conditions of an injection temperature of 200° C. and a detector temperature of 200° C., with the temperature programmed condition (held for 5 minutes at 50° C., then heated at 5° C./min, and held for 10 minutes at 250° C.).

As the sample for measurement, a 30 ml mixture solution prepared by dissolving about 1 g of the sample (positive charge controlling agent) in benzyl alcohol was used between the reaction time of 0 and 10 minute(s), and a 30 ml mixture solution prepared by dissolving about 1 g of the sample (positive charge controlling agent) in ethyl acetate was used between the reaction time of 11 to 30 minutes (peak area of hexadecane).

All peaks detected by this measurement were calculated out as an organic compound having low boiling point by toluene conversion (preliminarily measuring the peak area vs. toluene mass), and the amount (ppm) of organic compound having low boiling point contained in the sample (positive charge controlling agent) was determined.

Amount (ppm) of organic compound having low boiling point contained in the sample (positive charge controlling agent)=30,000×total peak area×toluene mass/toluene peak area/sample mass×1,000,000

(b) Organoleptic Test (Odor)

5 g of the sample (positive charge controlling agent) was placed in a petri dish and heated to 100° C. The organoleptic test was done by 3 examiners on a scale of 1 to 5. The average rating was calculated.

Rating scores are as follows:

5: there is very strong odor
4: there is strong odor
3: there is odor
2: there is slight odor
1: there is almost no odor

(c) Charge Measurement (Blow off Chargeability Evaluation)

The obtained toner and a carrier (F-96, manufactured by Powder Tech, Corp.) were blended at a ratio of 3:100, and the mixture was triboelectrically charged under conditions of 22° C. and 60% RH for 1 hour. The amount of charge was measured using a blow off powder charge measuring device (manufactured by Toshiba Chemical Co., Ltd.).

Process for Preparing Other Toners

T-2

100 parts of a styrene-acryl copolymer resin, 3 parts of the positive charge controlling agent, and 4 parts of copper phthalocyanine oil dye (Spilion Blue 2BNH, manufactured by Hodogaya Chemical Co., Ltd.) were blended, and the blend was melt-kneaded by a Laboplasto mill. The kneaded mixture was pulverized by a jet mill, and then the particles were classified to prepare a toner having a particle diameter of 5 to 15 μm. To this toner, 0.6 parts of Silica R-972 was uniformly applied as an external additive.

T-3

100 parts of a polyester resin (acid value of 10 mg KOH/g, and hydroxyl value of 15 mg KOH/g), 3 parts of the positive charge controlling agent, 4 parts of carbon black, and 3 parts of Biscol 550P were blended, and the blend was melt-kneaded by a Laboplasto mill. The kneaded mixture was pulverized by a jet mill, and then the particles were classified to prepare a toner having a particle diameter of 5 to 15 μm. To this toner, 0.6 parts of Silica R-972 was uniformly applied as an external additive.

T-4

100 parts of a styrene-acryl copolymer resin, 0.5 parts of the positive charge controlling agent, 4 parts of carbon black, and 3 parts of Biscol 550P were blended, and the blend was melt-kneaded by a laboplasto mill. The kneaded mixture was pulverized by a jet mill, and then the particles were classified to prepare a toner having a particle diameter of 5 to 15 μm. To this toner, 0.6 parts of Silica R-972 was uniformly applied as an external additive.

T-5

100 parts of a styrene-acryl copolymer resin, 15 parts of the positive charge controlling agent, 4 parts of carbon black, and 3 parts of Biscol 550P were blended, and the blend was melt-kneaded by a Laboplasto mill. The kneaded mixture was pulverized by a jet mill, and then the particles were classified to prepare a toner having a particle diameter of 5 to 15 μm. To this toner, 0.6 parts of Silica R-972 was uniformly applied as an external additive.

### Examples 2 to 8 and Comparative Example 4

Positive charge controlling agents were produced in the same manner as in Example 1, except that the type of the polymerization initiator to be used was changed as indicated in Table 1. However, for Example 8, n-butanol was used instead of isobutanol and the polymerization temperature was changed to 115° C., and for Comparative Example 4, an azo-based initiator was used instead of the peroxide-based initiator.

In addition, toners were prepared on the basis of the toner preparation method indicated in Table 1. With regard to these obtained agents and toners, various measurements and evaluation were carried out as in Example 1. The results are shown in Table 1.

### Examples 9 and 10

Positive charge controlling agents and toners were obtained in the same manner as in Example 1. However, for Example 9, the copolymerizing ratio of monomers, (M1)+(M2):(M3), was changed to 98.7:1.3, using 18 g of diethylaminoethyl(meth)acrylate, 2 g of methyl paratoluene sulfonic acid, and 242 g of styrene.

For Example 10, the copolymerizing ratio of monomers, (M1)+(M2):(M3), was changed to 71.7:28.3, using 45 g of diethylaminoethyl(meth)acrylate, 45 g of methyl paratoluene sulfonic acid, and 156 g of styrene.

With regard to these obtained agents and toners, various measurements and evaluation were carried out as in Example 1. The results are shown in Table 1.

### Comparative Example 1

### Production of Positive Charge controlling Agent

A 2-liter flask equipped with a stirrer, a condenser, a thermometer, and a nitrogen introducing tube was charged with 180 g of isobutanol as the reaction solvent, and 18 g of diethylaminoethyl(meth)acrylate, 210 g of styrene, 72 g of butylacrylate, and 12 g of t-butylperoxy-2-ethylhexanoate which serves as a peroxide-based initiator, the mixture was heated to 95° C. (polymerization temperature), and stirred for 3 hours under nitrogen. Thereafter, to this reaction solution, 6 g of t-butylperoxy-2-ethylhexanoate was further added while supplying nitrogen, and the mixture was stirred for 3 hours. Next, 18 g of methyl paratoluene sulfonic acid was added thereto, and the mixture was stirred for 1 hour to subject to a quaternization reaction, thereby obtaining a polymer solution. The polymer solution was dried with heating under reduced pressure (initial temperature of 140° C., pressure is reduced down to 10 kPa or below) to remove the solvent fraction, thereby obtaining a polymer. This polymer was subjected to cracking to obtain a positive charge controlling agent.

The copolymerizing ratio (%) of the styrene monomer (M1), the (meth)acrylic acid alkyl ester monomer (M2), and the quaternary ammonium salt (M3) of the dialkylaminoalkyl(meth)acrylate monomer, (M1)+(M2):(M3), was 88.7:11.3.

Preparation of Toner, and Various Measurements and Evaluation

A toner was prepared in the same manner as in Example 1 with the use of the obtained positive charge controlling agent.

With regard to the positive charge controlling agent and the toner, various measurements and evaluation were carried out as in Example 1. The results are shown in Table 1.

### Comparative Examples 2 and 3

Positive charge controlling agents and toners were obtained in the same manner as in Comparative Example 1, except that an azo-based initiator was used as the polymerization initiator as indicated in Table 1. With regard to these agents and toners, various measurements and evaluation were carried out in the same manner as in Example 1. The results are shown in Table 1.

TABLE 1

| | | Polymeri- | Toner | L-pt | Organo- | |
|---|---|---|---|---|---|---|
| | | zation | prepa- | Organic | leptic | Amount of |
| | | Initia- | ration | Comp.*2 | Test | charge*4 |
| | | tor*1 | method | (ppm) | Score*3 | (μC/g) |
| Examples | 1 | G1 | T-1 | 2800 | 1.7 | 26 |
| | 2 | G1 | T-2 | 2800 | 1.7 | 29 |
| | 3 | G1 | T-3 | 2800 | 1.7 | 20 |
| | 4 | G1 | T-4 | 2800 | 1.7 | 17 |
| | 5 | G1 | T-5 | 2800 | 1.7 | 22 |
| | 6 | G2 | T-1 | 2900 | 1.7 | 26 |
| | 7 | G3 | T-1 | 3900 | 2.3 | 24 |
| | 8 | G4 | T-1 | 3100 | 2.0 | 25 |
| | 9 | G1 | T-1 | 2500 | 1.3 | 16 |
| | 10 | G1 | T-1 | 3200 | 2.3 | 21 |
| Comp. | 1 | G1 | T-1 | 2900 | 2.3 | 9 |
| Examples | 2 | G5 | T-1 | 15000 | 4.3 | 25 |
| | 3 | G6 | T-1 | 16000 | 4.7 | 26 |
| | 4 | G5 | T-1 | 15000 | 4.3 | 25 |

*1G1 to G4 are peroxide-based initiators, and G5 and G6 are azo-based initiators
*2Defined as good if the L-pt organic compound is 8000 ppm or less
*3Defined as good if the organoleptic test score is 3.0 or below
*4Defined as good if the amount of charge is 10 μC/g or more
L-pt Organic Comp: organic compound having low boiling point
Comp. Examples: Comparative Examples
Symbols in the table represent the following contents:
G1: t-butylperoxy-2-ethylhexanoate (produced by Arkema Yoshitomi, Ltd.)
G2: t-amylperoxy-2-ethylhexanoate (produced by Arkema Yoshitomi, Ltd.)
G3: di-benzoyl peroxide (produced by Arkema Yoshitomi, Ltd.)
G4: 1,1-(t-butylperoxy)cyclohexane (produced by Arkema Yoshitomi, Ltd.)
G5: 2,2′-azobis(2-methylbutylonitrile) (V-59, produced by WAKO, Inc.)
G6: 2,2′-azobis(isomethylbutylonitrile) (V-60, produced by WAKO, Inc.)

As is clear from Table 1, the content of organic compounds having low boiling points was small in positive charge controlling agents obtained in Examples, and there were no cases where strong odor was sensed. In addition, toners obtained using such positive charge controlling agents were excellent in chargeability. Thus, it is suggested that when toners of Examples are used, a production of VOC can be controlled and a high printing quality can be obtained.

On the other hand, the toner obtained in Comparative Example 1 by carrying out a quaternization reaction after copolymerizing monomers was deteriorated in chargeability. The positive charge controlling agents obtained in Comparative Examples 2 and 3 with the use of an azo-based initiator as the polymerization initiator had an increased content of organic compounds having low boiling points, thus strong odor was sensed. Further, even in the case of Comparative Example 4 where the quaternization reaction was carried out before the copolymerization, when the azo-based initiator was used as the polymerization initiator, the content of organic compounds having low boiling points was increased, thus strong odor was sensed.

### INDUSTRIAL APPLICABILITY

According to the positive charge controlling agent of the invention, excellent compatibility with and dispersibility in a binder resin can be exhibited, discoloring is prevented, excellent chargeability is exhibited, and reduced content of organic compounds having low boiling points is obtained, thereby giving no strong odor. In addition, an electrophotographic toner including the positive charge controlling agent can exhibit excellent chargeability and colorability, and controlled production of VOC.

1. A positive charge controlling agent comprising a copolymer obtained by copolymerizing a styrene monomer (M1), a (meth)acrylic acid alkyl ester monomer (M2), and a quaternary ammonium salt (M3) of a dialkylaminoalkyl(meth)acrylate monomer,
wherein a copolymerizing ratio (mass %) of the monomers, (M1)+(M2):(M3), is 99.5:0.5 to 65:35, and at least one end is RCOO— or RO—, where R is an alkyl group, an aryl group, an aralkyl group, or an alicyclic group.

2. A process for producing the positive charge controlling agent according to claim 1, comprising converting a dialkylaminoalkyl(meth)acrylate monomer into the quaternary ammonium salt (M3) by quaternization, and then copolymerizing with the styrene monomer (M1) and the (meth)acrylic acid alkyl ester monomer (M2) with the use of a peroxide-based initiator.

3. The process according to claim 2, wherein the quaternary ammonium salt (M3) of the dialkylaminoalkyl(meth)acrylate monomer is represented by the following formula (1): 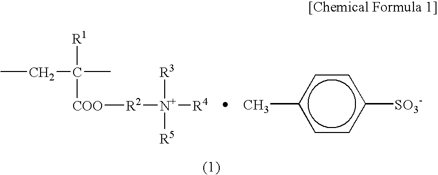
wherein R¹ is a hydrogen atom or a methyl group, R² is an alkylene group, and R³ to R⁵ are each an alkyl group.

4. The positive charge controlling agent according to claim 1, wherein the content of organic compounds having low boiling points is 0.8 mass % or less.

5. An electrophotographic toner comprising 0.1 to 20 parts by mass of the positive charge controlling agent according to claim 1 or 4, with respect to 100 parts by mass of a binder resin.
